(19) United States
(12) Patent Application Publication
(10) Pub. No.: US 2010/0193491 A1
(43) Pub. Date: Aug. 5, 2010

(54) UNIT FOR SUPPORTING A SUBSTRATE AND APPARATUS FOR PROCESSING A SUBSTRATE HAVING THE SAME

(76) Inventors: Sang-Bum Cho, Seoul (KR); Byoung-Jin Jung, Seoul (KR); Myung-Ha Park, Gyeonggi-do (KR); Jung-Hyun Park, Gyeonggi-do (KR)

Correspondence Address: DALY, CROWLEY, MOFFORD & DURKEE, LLP, SUITE 301A, 354A TURNPIKE STREET, CANTON, MA, 02021-2714, US

(21) Appl. No.: 12/676,024

(22) PCT Filed: Aug. 27, 2008
(86) PCT No.: PCT/KR08/05015

§ 371 Date: Mar. 2, 2010

(30) Foreign Application Priority Data
Sep. 5, 2007 (KR) 10-2007-0089762

(51) Int. Cl. H05B 1/00

(52) U.S. Cl. 219/158

(57) ABSTRACT

A substrate support unit of a substrate processing apparatus includes a first support member, a second support member, a buffer member and a tube. The first support member has an electrode and a heater built-in and supports the substrate. The second support member is disposed beneath the first support member to support the first support member. The buffer member is disposed between the first support member and the second support member to form an air gap between the first support member and the second support member so as to reduce heat transfer between the first support member and the second support member. The tube is connected with a lower surface of the first support member. Further, the tube extends through the second support member and receives lines for applying power to the electrode and the heater.

### TECHNICAL FIELD

The example embodiments relate generally to a unit for supporting a substrate, and an apparatus for processing a substrate having the same. More particularly, the example embodiments relate to a unit for supporting and heating a substrate for the purpose of processing the substrate, and an apparatus for processing a substrate having the same.

### BACKGROUND ART

In a semiconductor or flat panel display processing technology, various processes are generally performed to manufacture semiconductor devices or flat panel displays while a substrate, such as a silicon wafer and a glass substrate, is supported by a substrate support unit in a vacuum chamber. Examples of the substrate support unit may include a clamp using mechanical force, a vacuum chuck using vacuum force, an electrostatic chuck using electrostatic force, and the like.

The clamp is complicated in structure and may be easily contaminated or deformed while performing the processes. Further, a surface portion of the vacuum chuck, to which the substrate is held, may be easily deformed and is not suitable to use in a vacuum environment.

On the contrary, the electrostatic chuck is simple in structure and may hold the substrate without deforming the substrate. Further, a heater may be easily mounted to the electrostatic chuck to improve processability of the substrate.

An example of a substrate support unit having a heater is disclosed in U.S. Pat. No. 6,538,872 issued to Wang, et al.

FIG. 1 is a cross-sectional view illustrating a conventional unit for supporting a substrate.

Referring to FIG. 1, a substrate support unit 1 includes a dielectric layer 10 supporting a substrate S and having a built in electrode 12, a base 20 disposed beneath the dielectric layer 10 and having a built-in heater 22, and a support section 30 beneath the base 20 to support the base 20. A first adhesive layer 40 is interposed between the dielectric layer 10 and the base 20, and a second adhesive layer 42 is interposed between the base 20 and the support section 30. Further, a sealing member 50 is interposed between the support section 30 and a chamber 60 to prevent vacuum leakage.

Each of the dielectric layer 10 and the base 20 includes a ceramic material having good heat transfer characteristics. Thus, heat generated by the heater 22 is transferred to the outside of the chamber 60 via the dielectric layer 10, the base 20 and the support section 30. As a result, the substrate placed on the dielectric layer 10 may be non-uniformly heated due to heat loss to the outside of the chamber 60.

Further, each of the first and second adhesive layers 40 and 42 includes metal and may thus react with a process gas for processing the substrate S. Metal impurities may be produced by reaction between the process gas and the first or second adhesive layers 40 or 42 and may contaminate the substrate S.

The support section 30 includes metal and has a thermal expansion coefficient different from that of the base 20 including the ceramic material. Thus, when the base 20 and the support section 30 are heated by the heater 22, thermal deformation in the base 20 and the support section 30 may occur.

The support section 30 has a cavity 32 to prevent the heat loss therethrough. However, the cavity 32 may not sufficiently prevent heat transfer to the chamber 60, and the sealing member 50 may thus be deteriorated by heat transferred through the support section 30. As a result, vacuum leakage may occur between the support section 30 and the chamber 60.

In conclusion, when processing the substrate using the substrate support section, the substrate S may be non-uniformly heated due to heat loss through the support section 30; the substrate S may be contaminated by the metal impurities; thermal deformation of the base 20 and the support section 30 may occur due to the difference in the thermal expansion coefficient between the base 20 and the support section 30; or vacuum leakage may occur between the support section 30 and the chamber 60 due to the deterioration of the sealing member 50.

### DISCLOSURE OF INVENTION

### Technical Problem

Example embodiments of the present invention provide a unit for supporting a substrate capable of reducing heat loss and uniformly heating the substrate.

Further, example embodiments of the present invention provide an apparatus for processing a substrate having a substrate support unit capable of reducing heat loss and uniformly heating the substrate.

### Technical Solution

In accordance with an aspect of the present invention, a unit for support a substrate may include a first support member having an electrode and a heater and supporting the substrate; a second support member disposed beneath the first support member to support the first support member; and a buffer member disposed between the first support member and the second support member to form an air gap between the first support member and the second support member so as to reduce heat transfer between the first support member and the second support member.

In accordance with some example embodiments of the present invention, the substrate support unit may further include a tube connected to a lower surface of the first support member. The tube may extend through the second support member and may receive lines for applying power to the electrode and the heater.

In accordance with some example embodiments of the present invention, the substrate support unit may further include a sealing member interposed between the second support member and the tube. Further, the substrate support unit may further include a cooling line disposed adjacent to the sealing member within the second support member to cool the sealing member.

In accordance with some example embodiments of the present invention, the tube may include a material substantially identical to that of the first support member.

In accordance with some example embodiments of the present invention, the substrate support unit may further include a cooling line disposed within the second support member to cool the second support member.

In accordance with some example embodiments of the present invention, the first support unit may include a ceramic material.

In accordance with some example embodiments of the present invention, the air gap between the first support member and the second support member may be about 0.1 to about 5 mm.

In accordance with some example embodiments of the present invention, a ratio of a contact area between the buffer member and the first support member to an area of a lower surface of the first support member may be about 0.05 to about 0.9.

In accordance with some example embodiments of the present invention, the buffer member may have a heat transfer coefficient of about 1 to about 30 W/(m·K).

In accordance with some example embodiments of the present invention, examples of a material that may be used for the buffer member may include Al₂O₃, Y₂O₃, ZnO, SiO₂, and the like. These materials may be used alone or in a combination thereof.

In accordance with another aspect of the present invention, an apparatus for processing a substrate may include a chamber, a substrate support unit and a gas supply section. The chamber may provide a space to process the substrate, and the gas supply section may supply a process gas onto the substrate to process the substrate. The substrate support unit may be disposed in the chamber and may include a first support member having an electrode and a heater and supporting the substrate, a second support member disposed beneath the first support member to support the first support member, and a buffer member disposed between the first support member and the second support member to form an air gap between the first support member and the second support member so as to reduce heat transfer between the first support member and the second support member.

### ADVANTAGEOUS EFFECTS

In accordance with the example embodiments of the present invention as described above, a first support member may support a substrate to process the substrate and may have a heater to heat the substrate. A second support member may support the first support member. A buffer member may be disposed between the first and second support members, and an air gap may be formed by the buffer member between the first and second support members.

Thus, heat transfer between the first and second support members may be reduced by the air gap, thereby heating the substrate effectively and uniformly.

A tube may be connected to a lower surface of the first support member and may extend through the second support member. The heater may be connected with a power source by a power line extending through the tube. That is, the power line may be easily connected to the heater by using the tube.

Further, a sealing member may be interposed between the second support member and the tube, and a cooling line may be disposed within the second support member. As a result, the cooling line may reduce thermal deformation of the second support member and deterioration of the sealing member due to heat transfer through the buffer member.

### BRIEF DESCRIPTION OF THE DRAWINGS

Example embodiments of the present invention will become readily apparent along with the following detailed description when considered in conjunction with the accompanying drawings, in which:

FIG. 1 is a cross-sectional view illustrating a conventional unit for supporting a substrate;

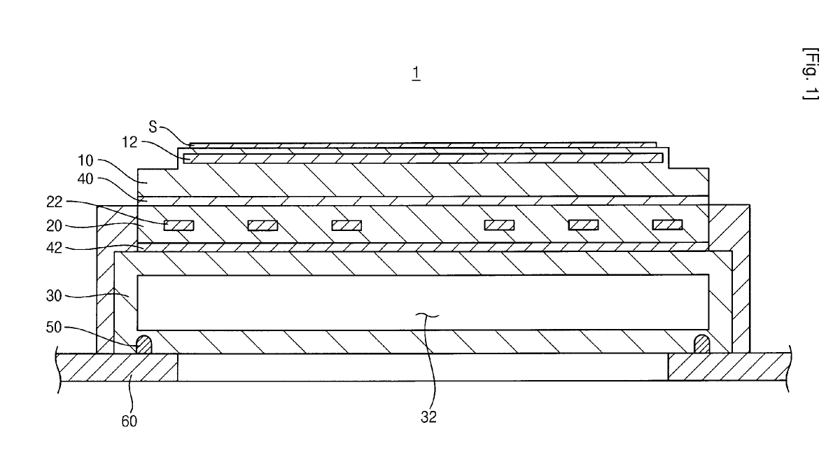

FIG. 2 is a cross-sectional view illustrating a unit for supporting a substrate in accordance with an example embodiment of the present invention; and

FIG. 3 is a cross-sectional view illustrating an apparatus for processing a substrate having the substrate support unit shown in FIG. 2.

### BEST MODE FOR CARRYING OUT THE INVENTION

The present invention is described more fully hereinafter with reference to the accompanying drawings, in which example embodiments of the present invention are shown. The present invention may, however, be embodied in many different forms and should not be construed as limited to the example embodiments set forth herein. Rather, these embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on” or “connected to” another element or layer, it can be directly on or connected to the other element or layer or intervening elements or layers may be present. In contrast, when an element is referred to as being “directly on” or “directly connected to” another element or layer, there are no intervening elements or layers present. Like reference numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Example embodiments of the present invention are described herein with reference to cross-sectional illustrations that are schematic illustrations of idealized embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. The regions illustrated in the figures are schematic in nature and their shapes are not intended to illustrate the actual shape of a region of a device and are not intended to limit the scope of the present invention.

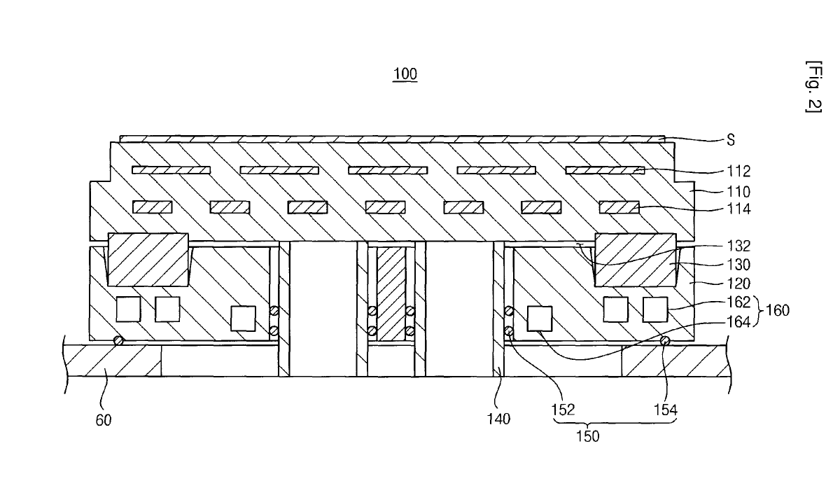

FIG. 2 is a cross-sectional view illustrating a unit for supporting a substrate in accordance with an example embodiment of the present invention.

Referring to FIG. 2, a unit 100 for supporting a substrate S, in accordance with an example embodiment of the present invention, may include a first support member 110, a second support member 120, a buffer member 130 and a tube 140, a sealing member 150, a cooling line 160, etc.

The first support member 110 may have a disc shape. The size of the first support member 110 may be equal to or greater than that of the substrate S, which may be used for manufacturing semiconductor devices or flat panel displays. The first support member 110 may be used to support the substrate S.

The first support member 110 may include sintered ceramic. Examples of a ceramic material that may be used for the sintered ceramic may include Al₂O₃, Y₂O₃, ZrO₂, AlC, TiN, AN, TiC, MgO, CaO, CeO₂, TiO₂, BₓC_{y}, BN, SiO₂, SiC, YAG, mullite, AlF₃, and the like. These ceramic materials may be used alone or in a combination thereof.

An electrode 112 and a heater 114 may be disposed within the first support member 110.

As shown in FIG. 2, the electrode 112 may be disposed near an upper surface of the first support member 110. In accordance with the present example embodiment, one electrode 112 may be employed. For example, the electrode 112 may be connected with a direct current (DC) power source. In such a case, an electrostatic force for holding the substrate S may be generated by the electrode 112. Alternatively, the electrode 112 may be connected with a high frequency power source. In such a case, plasma, which is generated in a vacuum chamber 60 to process the substrate S, may be directed onto the substrate S by the electrode 112. Further, the electrode 112 may be connected with both the DC power source and the high frequency power source. The DC power source and the high frequency power source may be connected to the electrode 112 individually or in a combination thereof. In such a case, a DC power and a high frequency power may be selectively applied to the electrode 112.

In accordance with another example embodiment of the present invention, two electrodes may be employed. For example, the electrode 112 may include a first electrode and the second electrode. The first and second electrodes may not be connected with each other and may be connected to the DC power sources different from each other, respectively. For example, positive power may be applied to the first electrode, and negative power may be applied to the second electrode.

Meanwhile, the high frequency power source may include a band filter such as a low-pass filter, a high-pass filter, a band-pass filter and a band-rejection filter.

The electrode 112 may include a material having relatively low electrical resistance and a relatively low thermal expansion coefficient. Examples of the material that may be used for the electrode 112 may include tungsten (W), molybdenum (Mo), silver (Ag), gold (Au) or an alloy thereof.

The heater 114 may be disposed under the electrode 112 within the first support member 110. The heater 114 may be connected to a power source and may be used to heat the substrate S. The substrate S may be heated to the temperature of about 250 to about 350° C.

The heater 114 may include a material having relatively low electrical resistance. Examples of the material that may be used for the heater 114 may include tungsten (W), molybdenum (Mo), tantalum (Ta) or an alloy thereof.

The second support member 120 may have a disc shape and may be disposed under the first support member 110. The second support member 120 may include a metal.

The buffer member 130 may be disposed between the first support member 110 and the second support member 120. Particularly, the buffer member 130 may be disposed on the second support member 120 and may partially support the first support member 110. The first support member 110 may be spaced apart from the second support member 120 by the buffer member 130. For example, the buffer member 130 may have a ring shape. Alternatively, the buffer member 130 may include a plurality of blocks for support the first support member 110. The buffer member 130 may be provided to reduce heat transfer between the first support member 110 and the second support member 120.

The buffer member 130 may be brought into partial contact with the first support member 110 and the second support member 120. Particularly, a first ratio of a contact area between the first support member 110 and the buffer member 130 to an area of a lower surface of the first support member 110 may be about 0.05 to about 0.9.

As described above, because the second support member 120 is not in direct contact with the first support member 110, and the buffer member 130 is brought into partial contact with the first support member 110, the heat transfer between the first support member 110 and second support member 120 may be reduced. As a result, heat loss through the second support member 120 may be reduced.

Meanwhile, a second ratio of a contact area between the buffer member 130 and the second support member 120 to an area of an upper surface of the second support member 120 may be about 0.05 to about 0.9, too.

When the first ratio is less than about 0.05, it is difficult to allow the buffer member 130 to stably support the first support member 110, and when the first ratio is more than about 0.9, it is difficult to effectively reduce the heat loss through the second support member 120.

Further, when the second ratio is less than about 0.05, the first support member 110 and the buffer member 130 are unstable, and when the second ratio is more than about 0.9, it is difficult to effectively reduce the heat loss through the second support member 120.

Meanwhile, because the first support member 110 is spaced apart from the second support member 120, an air gap 132 may be formed between the first support member 110 and the second support member 120. The air gap 132 may reduce the heat transfer between the first support member 110 and the second support member 120, and the heat loss through the second support member 120 may be reduced.

The air gap 132 between the first support member 110 and the second support member 120 may be about 0.1 to about 5 mm.

When the air gap 132 is less than about 0.1 mm, the heat transfer between the first substrate member 110 and the second support member 120 may not be sufficiently reduced. Further, when the air gap is more than about 5 mm, the heat transfer between the first substrate member 110 and the second support member 120 may be sufficiently reduced, but the size of the substrate support unit 100 may be increased.

The first support member 110 and the second support member 120 may have a first recess and a second recess, respectively. The width of the first recess may have a tolerance of about 0.2 to about 1 percent with respect to the width of the buffer member 130 in consideration of heat expansion of the first support member 110 and the buffer member 130. Further, the width of the second recess may have a tolerance of about 0.2 to about 2 percent with respect to the width of the buffer member 130 in consideration of heat expansion of the second support member 120 and the buffer member 130.

The buffer member 130 may include a material having thermal shock resistance and a relatively low heat transfer coefficient. For example, the buffer member 130 may have a heat transfer coefficient of about 1 to about 30 W/(m·K). Thus, the heat loss through the buffer member 130 and the second support member 130 may be reduced.

When the heat transfer coefficient of the buffer member 130 is more than about 30 W/(m·K), the heat loss through the buffer member 130 and the second support member 120 may not be sufficiently reduced.

Examples of a material that may be used for the buffer member 130 may include quartz, Al₂O₃, Y₂O₃, ZnO, SiO₂, and the like. These materials may be used alone or in a combination thereof.

The buffer member 130 and the air gap 132 may reduce the heat transfer from the heater 114 to the second support member 120, and the heat loss through the second support member 120 may thus be reduced.

The tube 140 may be connected to the lower surface of the first support member 110 and may extend through the second support member 120. The tube 140 may include a ceramic material substantially identical to that of the first support member 110.

The tube 140 may be joined to the first support member 110 by a sintering process using a ceramic binder or a brazing process using a metal filler. Thus, when the substrate support unit 100 is disposed in the vacuum chamber 60 to process the substrate S, vacuum leakage between the first support member 110 and the tube 140 may be prevented.

Further, because the tube 140 has a hollow, heat loss through the tube 140 may be reduced.

Although not shown in figures, power lines for applying power to the electrode 112 and the heater 114 may be received in the tube 140 and may be connected to the electrode 112 and the heater 114 through the tube 140. Further, a temperature sensor (not shown) for measuring the temperature of the first support member 110 and a signal line connected to the temperature sensor may be disposed in the tube 140. Thus, the power lines may be easily connected to the electrode 112 and the heater 114 through the tube 140, and the temperature sensor may be easily mounted on the first support member 110 through the tube 140.

The sealing member 150 may include a first sealing member 152 and a second sealing member 154.

The first sealing member 152 may be interposed between the second support member 120 and the tube 140. Thus, vacuum leakage between the second support member 120 and the tube 140 may be prevented. The second sealing member 154 may be interposed between the second support member 120 and the vacuum chamber 60. Thus, vacuum leakage between the second support member 120 and the vacuum chamber 60 may be prevented. The first and second sealing members 152 and 154 may include, for example, an o-ring.

The cooling line 160 may include a first cooling line 162 and a second cooling line 164.

The first cooling line 162 may be disposed within the second support member 120 to cooling the second support member 120. Particularly, the first cooling line 162 may be disposed adjacent to the buffer member 130 within the second support member 120. The first cooling line 162 may be provided to prevent the second support member 120 from being deformed by heat transferred through the buffer member 130.

The second cooling line 164 may be disposed adjacent to the first sealing member 152 within the second support member 120 to cooling the first sealing member 152. The second cooling line 164 may be provided to prevent the first sealing member 152 from being deteriorated by heat transferred through the tube 140.

For example, the first cooling line 162 and the second cooling line 164 may be individually provided. Alternatively, the first cooling line 162 and the second cooling line 164 may be connected to each other.

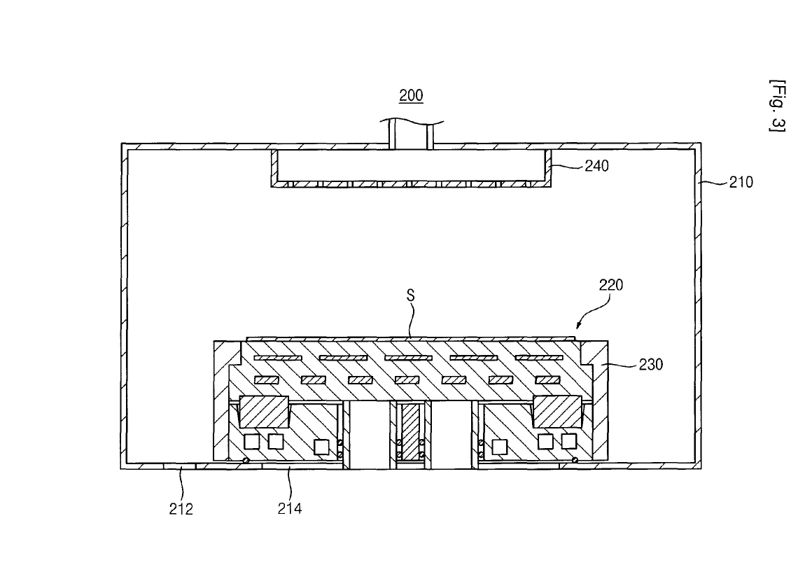

FIG. 3 is a cross-sectional view illustrating an apparatus for processing a substrate having the substrate support unit shown in FIG. 2.

Referring to FIG. 3, an apparatus 200 for processing a substrate S may include a chamber 210, a substrate support unit 220, a protective member 230, a gas supply section 240, etc.

The chamber 210 may provide a space to process the substrate S. The chamber 210 may have an exhaust port 212 formed through a lower portion of the chamber 210 to exhaust by-products and/or a process gas. Further, the chamber 210 may have an opening 214 formed through a center portion of the lower portion of the chamber 210. The opening 214 may serve as a passage for power lines and/or signal lines, which are connected to the substrate support unit 220.

The substrate support unit 220 may be disposed in the chamber 210. Particularly, the substrate support unit 220 may be disposed on the lower portion of the chamber 210 so as to cover the opening 214. The substrate support unit 220 may include a first support member, a second support member, a buffer member, a tube, a sealing member, a cooling line, etc.

Further detailed descriptions for the first support member, the second support member, the buffer member, the tube, the sealing member and the cooling line will be omitted because these elements are similar to the first support member 110, the second support member 120, the buffer member 130, the tube 140, the sealing member 150 and the cooling line 160 already described with reference to FIG. 2.

The protective member 230 may have a ring shape and may cover a side of the substrate support unit 220. The protective member 230 may prevent the process gas, which is used to process the substrate S, from penetrating into the substrate support unit 220 to thereby protect the substrate support unit 220. The protective member 230 may include a ceramic material without reacting with the process gas.

The gas supply section 240 may supply the process gas into the chamber 210 to process the substrate S supported by the substrate support unit 220. For example, the gas supply section 240 may include a shower head disposed over the substrate support unit 220 in the chamber 210. The shower head may be connected to a high frequency power source to generate a plasma from the process gas. Examples of the process gas may include a source gas for forming a layer on the substrate S, an etching gas for etching a layer on the substrate S, a cleaning gas for cleaning the substrate S and/or inner surfaces of the chamber 210.

### INDUSTRIAL APPLICABILITY

In accordance with the example embodiments of the present invention as described above, a first support member may support a substrate to process the substrate and may have a heater to heat the substrate. A second support member may support the first support member. A buffer member may be disposed between the first and second support members, and an air gap may be formed by the buffer member between the first and second support members.

Thus, heat transfer between the first and second support members may be reduced by the air gap, thereby heating the substrate effectively and uniformly.

A tube may be connected to a lower surface of the first support member and may extend through the second support member. The heater may be connected with a power source by a power line extending through the tube. That is, the power line may be easily connected to the heater by using the tube.

Further, a sealing member may be interposed between the second support member and the tube, and a cooling line may be disposed within the second support member. As a result, the cooling line may reduce thermal deformation of the second support member and deterioration of the sealing member due to heat transfer through the buffer member.

Although the example embodiments of the present invention have been described, it is understood that the present invention should not be limited to these example embodiments but various changes and modifications can be made by those skilled in the art within the spirit and scope of the present invention as hereinafter claimed.

1. A unit for supporting a substrate comprising:
a first support member having an electrode and a heater and supporting the substrate;
a second support member disposed beneath the first support member to support the first support member; and
a buffer member disposed between the first support member and the second support member to form an air gap between the first support member and the second support member so as to reduce heat transfer between the first support member and the second support member.

2. The unit of claim 1, further comprising a tube connected to a lower surface of the first support member, the tube extending through the second support member and receiving lines for applying power to the electrode and the heater.

3. The unit of claim 2, further comprising a sealing member interposed between the second support member and the tube.

4. The unit of claim 3, further comprising a cooling line disposed adjacent to the sealing member within the second support member to cool the sealing member.

5. The unit of claim 2, wherein the tube comprises a material substantially identical to that of the first support member.

6. The unit of claim 1, further comprising a cooling line disposed within the second support member to cool the second support member.

7. The unit of claim 1, wherein the first support unit comprises a ceramic material.

8. The unit of claim 1, wherein the air gap between the first support member and the second support member is about 0.1 to about 5 mm.

9. The unit of claim 1, wherein a ratio of a contact area between the buffer member and the first support member to an area of a lower surface of the first support member is about 0.05 to about 0.9.

10. The unit of claim 1, wherein the buffer member has a heat transfer coefficient of about 1 to about 30 W/(m·K).

11. The unit of claim 1, wherein the buffer member is any one selected from the group consisting of Al₂O₃, Y₂O₃, ZnO and SiO₂.

12. An apparatus for processing a substrate comprising:
a chamber providing a space to process the substrate;
a substrate support unit disposed in the chamber and comprising a first support member having an electrode and a heater and supporting the substrate, a second support member disposed beneath the first support member to support the first support member, and a buffer member disposed between the first support member and the second support member to form an air gap between the first support member and the second support member so as to reduce heat transfer between the first support member and the second support member; and a gas supply section supplying a process gas onto the substrate to process the substrate.
